(19) United States
(12) Patent Application Publication
(10) Pub. No.: US 2015/0302978 A1
(43) Pub. Date: Oct. 22, 2015

(54) BOBBIN STRUCTURE WITH WINDING GROOVES FOR ADJUSTING COUPLING

(71) Applicant: Sen-Tai Yang, New Taipei City (TW)

(72) Inventor: Sen-Tai Yang, New Taipei City (TW)

(73) Assignee: YUJING TECHNOLOGY CO., LTD., New Taipei City (TW)

(21) Appl. No.: 14/578,458

(22) Filed: Dec. 21, 2014

(30) Foreign Application Priority Data
Apr. 17, 2014 (TW) 103114046

(51) Int. Cl. H01F 27/30; H01F 27/29; H01F 27/28

(52) U.S. Cl. CPC H01F 27/303; H01F 27/2823; H01F 27/29; H01F 2027/297

(57) ABSTRACT

A bobbin structure with winding grooves for adjusting coupling at least includes: a bobbin body, a hole provided in the bobbin body for allowing magnetic wires to pass through, and at least three separated winding grooves with different lengths provided around the outer peripheral side of the hole. The primary winding (or the secondary winding) of the coils of a transformer is selectively wound into one of the winding groove, while the secondary windings (or the primary windings) are wound into the rest of the winding grooves. By altering the numbers of turns of the secondary windings (or the primary windings) distributed in the winding grooves, different coupling effects can be achieved with respect to the primary winding (or the secondary winding). As a result, the transformer leakage inductance and the output impedance can be conveniently adjusted. The design of multiple grooves also reduces the stray capacitances of the windings, thereby increasing the bandwidth of the transformer.

### BACKGROUND OF THE INVENTION

1. Field of the Invention

The invention relates to a bobbin structure with winding grooves for adjusting coupling, and more particularly, to a bobbin structure that allows for simple adjustment of the overall leakage inductance and output impedance as well as working bandwidth improvement by altering the relative magnetic coupling positions of the windings of the coils.

2. Description of the Prior Art

A simple structure of a conventional transformer bobbin has only one winding groove onto which the primary and the secondary windings are wound in sequence (normally the primary winding is wound onto the inner peripheral side of the winding groove and the secondary winding is then wound onto the outer peripheral side of the primary winding) so as to form a fixed magnetic coupling between the primary and the secondary windings.

Another design includes providing two separated grooves around the bobbin, whereas the primary and secondary windings of the coils are wound onto the two grooves, respectively, so as to form a fixed magnetic coupling between the primary and the secondary windings. The secondary winding induces a voltage as a result of the magnetic field created by the primary winding.

In these two traditional structures above, since the relative positions of the primary and the secondary windings are fixed, the magnetic coupling characteristic cannot be altered. As a result, it is difficult to adjust the leakage inductance between the primary and the secondary windings. For a LLC resonant circuit, in general practice, an external resonant inductor has to be added in addition to the main transformer. In recent practice, there is an integrated transformer approach in which the leakage inductance is used as the resonant inductance. This type of integrated transformer saves circuit board space and is more cost effective. However, the leakage inductance cannot be easily adjusted due to the fixed positions of the primary and the secondary windings.

Currently, there is another approach in which an external resonant inductor is integrated into the transformer. Nonetheless, the leakage inductance is increased through creating more distance between the primary and the secondary windings, which reduces the space available for coil winding, and ultimately leads to an increase in the size of the transformer. Furthermore, the primary and the secondary windings are not in separate grooves, which results in large stray capacitance and reduces the working bandwidth of the transformer.

In view of the abovementioned shortcomings in conventional transformer bobbins, the present invention is proposed to provide improvements that address these shortcomings.

### SUMMARY OF THE INVENTION

One main objective of the present invention is to provide a bobbin structure with winding grooves for adjusting coupling, wherein at least three separated winding grooves with different lengths are provided. A primary winding (or secondary winding) of coils is wound onto one of the winding grooves, while secondary windings (or primary windings) of the coils are wound onto the rest of the at least two winding grooves depending on the preset requirements. Different coupling effects can be achieved between the primary winding(s) and the secondary winding(s) by providing different distances between the winding grooves in conjunction with altering the numbers of turns of the secondary windings (or the primary windings) distributed in the winding grooves. As a result, the overall output impedance of the transformer can be conveniently adjusted. The design of multiple winding grooves may also reduce the stray capacitances of the windings, thereby increasing the bandwidth of the transformer.

Another objective of the present invention is to provide a bobbin structure with winding grooves for adjusting coupling which allows integration of the external resonant inductance into transformer, thereby simplifying the assembly of the overall structure and improving space utilization.

In order to achieve the above objectives and efficacies, the technical means employed by the present invention may include: a bobbin body, a hole provided in the bobbin body for allowing magnetic wires to pass through, at least three separated winding grooves provided around the outer peripheral side of the hole, wherein one of the winding grooves is for winding a primary winding of a transformer, and the rest of the winding grooves are for selectively winding secondary windings of the transformer.

In the above structure, each of the winding grooves has a different length.

In the above structure, a base extending sideways is provided on at least one end of the bobbin body closer to the hole, and a plurality of conductive pins are provided on the base.

The technical means employed by the present invention may further include: a bobbin body, a hole provided in the bobbin body for allowing magnetic wires to pass through, at least three separated winding grooves provided around the outer peripheral side of the hole, wherein one of the winding grooves is for winding a secondary winding of a transformer, and the rest of the winding grooves are for selectively winding primary windings of the transformer.

In the above structure, each of the winding grooves has a different length.

In the above structure, a base extending sideways is provided on at least one end of the bobbin body closer to the hole, and a plurality of conductive pins are provided on the base.

The accomplishment of this and other objectives of the invention will become apparent from the following description and its accompanying drawings of which:

### BRIEF DESCRIPTION OF THE DRAWINGS

FIG. 1 is an exploded perspective view of a first embodiment and its relevant components in accordance with the present invention.

FIG. 2 is an external view of the first embodiment and its relevant components in accordance with the present invention after assembly.

FIG. 3 is a cross-sectional view of the first embodiment and its relevant components in accordance with the present invention after assembly.

FIG. 4 is a cross-sectional view of a second embodiment and its relevant components in accordance with the present invention after assembly.

FIG. 5 is a cross-sectional view of a third embodiment and its relevant components in accordance with the present invention after assembly.

FIG. 6 is a cross-sectional view of a fourth embodiment and its relevant components in accordance with the present invention after assembly.

### DETAILED DESCRIPTION OF THE PREFERRED EMBODIMENT

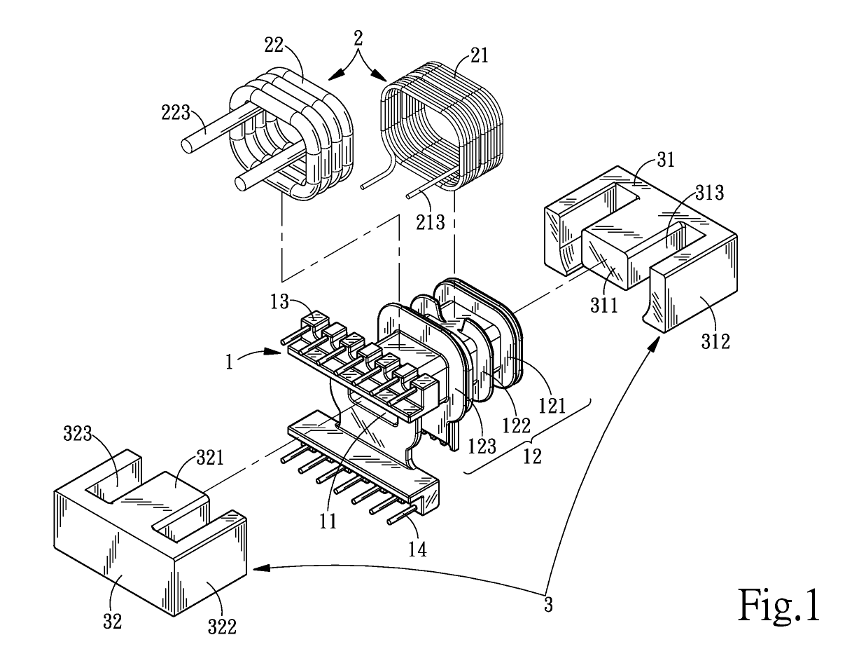

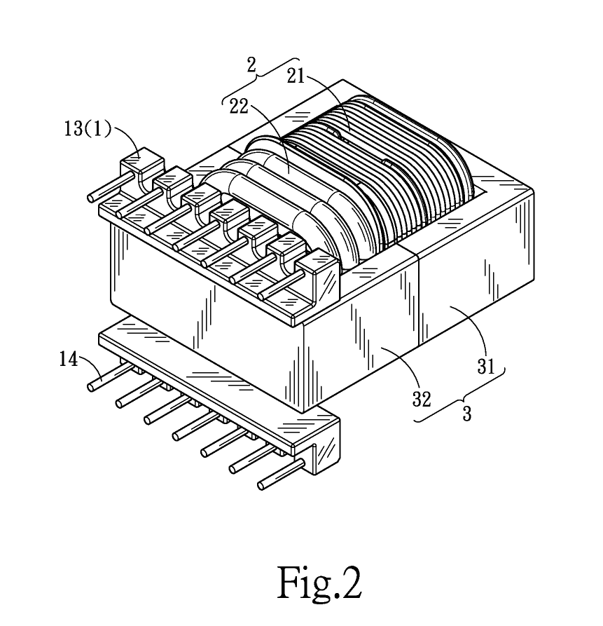

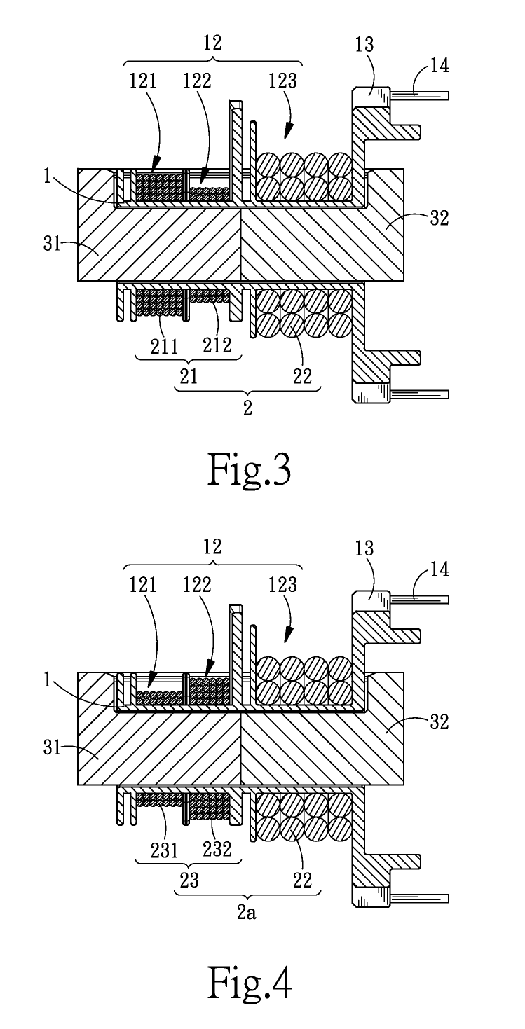

Referring to FIGS. 1 to 3, the structure in accordance with a first embodiment of the present invention mainly includes: a bobbin 1; a center hole 11 provided through the bobbin 1; a winding groove set 12 provided on the outer peripheral side of the center hole 11 made up of a first winding groove 121, a second winding groove 122, and a third winding groove 123; connecting portions 13 extending from either side of one end of the winding groove set 12; and a plurality of pins 14 on each of the connecting portions 13.

In actual practice, the bobbin 1 forms a basic transformer structure with coils 2 and a magnetic core set 3. The coils 2 are wound onto the periphery of the winding groove set 12 forming a primary winding 21 and a secondary winding 22. The primary and the secondary windings 21 and 22 have at least one set of terminals 213 and 223, respectively.

In one implementation, the first, the second, and the third winding grooves 121, 122, and 123 are designed into different lengths. The secondary winding 22 is wound onto the third winding groove 123, and the primary winding 21 is wound onto the first and the second winding grooves 121 and 122, forming two local windings 211 and 212. The number of turns of the local winding 211 on the first winding groove 121 is larger than that of the local winding 212 on the second winding groove 122.

The magnetic core set 3 is composed of two symmetric cores 31 and 32 opposite to each other. Middle bars 311 and 321 are provided in middle portions of the cores 31 and 32, respectively, and can be inserted into the center hole 11. Corresponding side bars 312 and 322 are provided on at least two sides of the middle bars 311 and 321. Receiving spaces 313 and 323 are formed between the respective middle bars 311 and 321 and the side bars 312 and 322 for receiving the winding groove set 12 of the bobbin 1 and the coils 2, such that the two magnetic cores 31 and 32 may form a magnetic loop around the bobbin 1 using the middle bars 311 and 321 and the side bars 312 and 322.

In the structure disclosed by this embodiment, after a voltage is applied, the respective local windings 211 and 212 having different numbers of turns in the first and the second winding grooves 121 and 122 will create magnetic fields of different strengths. Since the secondary winding 22 in the third winding groove 123 is at different distances with respect to the first and the second winding grooves 121 and 122, corresponding voltage outputs are induced from the magnetic fields created by the respective local windings 211 and 212. In this way, the leakage inductance of the secondary winding 22 can be adjusted by changing the number of turns of the local windings 211 and 212 in the first and the second winding grooves 121 and 122 of the primary winding 21.

Referring to FIG. 4, the structure in accordance with a second embodiment of the present invention mainly includes: a bobbin 1 that is the same as the first embodiment; in actual practice, the bobbin 1 forms a basic transformer structure in conjunction with coils 2a and the magnetic core set 3. The coils 2a are composed of primary and secondary windings 23 and 22.

In the structure disclosed by this embodiment, the secondary winding 22 is directly wound onto the third winding groove 123, and the primary winding 23 is wound onto the first and the second winding grooves 121 and 122 to form two local windings 231 and 232, and the number of turns of the local winding 231 in the first winding groove 121 is less than that of the local winding 232 in the second winding groove 122 (that is, the numbers of turns of the two local windings 231 and 232 are different from those of the two local windings 211 and 212).

The magnetic core set 3 is assembled with the bobbin 1 in the same way as that described in the first embodiment. Similarly, a magnetically induced loop can be formed around the bobbin 1. After a voltage is applied, the respective local windings 231 and 232 having different numbers of turns in the first and the second winding grooves 121 and 122 will create magnetic fields of different strengths. Since the secondary winding 22 in the third winding groove 123 is at different distances with respect to the first and the second winding grooves 121 and 122, corresponding voltage outputs are induced from the magnetic fields created by the respective local windings 231 and 232. Thereby, leakage inductance can be adjusted.

In this embodiment, even though the total number of turns of the primary winding 23 is the same as that of the primary winding 21 previously mentioned, the number of turns of the local winding 231 in the first winding groove 121 is less than that of the local winding 232 in the second winding groove 122 (that is, different from the distribution of turns for the local windings 211 and 212), so the primary winding 23 (i.e. two local windings 231 and 232) will have different degrees of coupling with the secondary winding 22 due to different coupling effects.

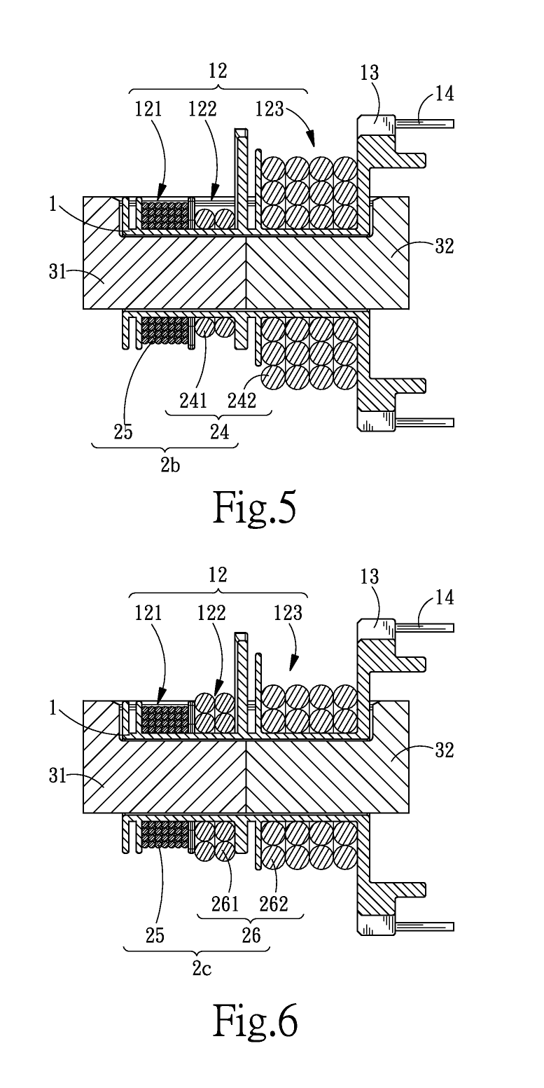

Referring to FIG. 5, the structure in accordance with a third embodiment of the present invention mainly includes: a bobbin 1 that is the same as the first embodiment; in actual practice, the bobbin 1 forms a basic transformer structure in conjunction with coils 2b and the magnetic core set 3. The coils 2b are composed of primary and secondary windings 25 and 24.

In the structure disclosed by this embodiment, the primary winding 25 is directly wound onto the first winding groove 121, and the secondary winding 24 is wound onto the second and the third winding grooves 122 and 123 to form two local windings 241 and 242, and the number of turns of the local winding 241 in the second winding groove 122 is much less than that of the local winding 242 in the third winding groove 123.

The magnetic core set 3 is assembled with the bobbin 1 in the same way as that described in the first embodiment. Similarly, a magnetically induced loop can be formed around the bobbin 1. After a voltage is applied, the primary winding 25 in the first winding groove 121 creates a magnetic field, and the respective local windings 241 and 242 having different numbers of turns in the second and the third winding grooves 122 and 123 will induce corresponding voltages from the magnetic field created by the primary winding 25 due to the different distances with respect to the first winding groove 121. As such, the degree of the overall magnetic field coupling can be adjusted by changing the distributions of the numbers of turns of the local windings 241 and 242 of the secondary winding 24 inside the respective second and third winding grooves.

Referring to FIG. 6, the structure in accordance with a fourth embodiment of the present invention mainly includes: a bobbin 1 that is the same as the first embodiment; in actual practice, the bobbin 1 forms a basic transformer structure in conjunction with coils 2c and the magnetic core set 3. The coils 2c are composed of primary and secondary windings 25 and 26.

In the structure disclosed by this embodiment, the primary winding 25 is directly wound onto the first winding groove 121, and the secondary winding 26 is wound onto the second and the third winding grooves 122 and 123 to form two local windings 261 and 262, and the number of turns of the local winding 261 in the second winding groove 122 is more than that of the local winding 241 previously mentioned, while the number of turns of the local winding 262 in the third winding groove 123 is less than that of the local winding 242 previously mentioned.

The magnetic core set 3 is assembled with the bobbin 1 in the same way as that described in the first embodiment. Similarly, a magnetically induced loop can be formed around the bobbin 1. After a voltage is applied, the primary winding 25 in the first winding groove 121 creates a magnetic field, and the respective local windings 261 and 262 having different numbers of turns in the second and the third winding grooves 122 and 123 will induce different voltages from the magnetic field created by the primary winding 25 due to the different distances with respect to the first winding groove 121, thereby achieving an adjustable magnetic coupling.

In this embodiment, even though the total number of turns of the secondary winding 26 is the same as that of the secondary winding 24 previously mentioned, the distribution of the number of turns of the local windings 261 and 262 in the second and the third winding grooves 122 and 123 is different from that of the numbers of turns of the two local windings 241 and 242 in the third embodiment above, so the secondary winding 26 (two local windings 261 and 262) will have a leakage inductance of the secondary winding 26 different from the third embodiment due to different coupling effects.

In summary, the bobbin structure with winding grooves for adjusting coupling in accordance with the present invention achieves the effect of adjustable transformer leakage inductance and output impedance by simply adjusting the relative magnetic coupling positions of the respective windings. In view of this, the present invention is submitted to be novel and non-obvious and a patent application is hereby filed in accordance with the patent law. It should be noted that the descriptions given above are merely descriptions of preferred embodiments of the present invention, various changes, modifications, variations or equivalents can be made to the invention without departing from the scope or spirit of the invention. It is intended that all such changes, modifications and variations fall within the scope of the following appended claims and their equivalents.

What is claimed is:

1. A bobbin structure with winding grooves for adjusting coupling comprising: a bobbin body, a hole provided in the bobbin body for allowing magnetic wires to pass through, at least three separated winding grooves provided around the outer peripheral side of the hole, wherein one of the winding grooves is for winding a primary winding of a transformer, and the rest of the winding grooves are for selectively winding secondary windings of the transformer.

2. The bobbin structure with winding grooves for adjusting coupling as claimed in claim 1, wherein each of the winding grooves has a different length.

3. The bobbin structure with winding grooves for adjusting coupling as claimed in claim 1, wherein a base extending sideways is provided on at least one end of the bobbin body closer to the hole, and a plurality of conductive pins are provided on the base.

4. A bobbin structure with winding grooves for adjusting coupling comprising: a bobbin body, a hole provided in the bobbin body for allowing magnetic wires to pass through, at least three separated winding grooves provided around the outer peripheral side of the hole, wherein one of the winding grooves is for winding a secondary winding of a transformer, and the rest of the winding grooves are for selectively winding primary windings of the transformer.

5. The bobbin structure with winding grooves for adjusting coupling as claimed in claim 4, wherein each of the winding grooves has a different length.

6. The bobbin structure with winding grooves for adjusting coupling as claimed in claim 4, wherein a base extending sideways is provided on at least one end of the bobbin body closer to the hole, and a plurality of conductive pins are provided on the base.
